(19) United States
(12) Patent Application Publication
(10) Pub. No.: US 2012/0038899 A1
(43) Pub. Date: Feb. 16, 2012

(54) EXPOSURE APPARATUS AND ALIGNMENT ERROR COMPENSATION METHOD USING THE SAME

(75) Inventors: Sung Min Ahn, Suwon-si (KR); Sang Don Jang, Suwon-si (KR); Seung Won Yang, Seoul (KR)

(73) Assignee: SAMSUNG ELECTRONICS CO., LTD., Suwon-si (KR)

(21) Appl. No.: 13/184,963

(22) Filed: Jul. 18, 2011

(30) Foreign Application Priority Data
Aug. 13, 2010 (KR) 10-2010-0078481

(51) Int. Cl. G03B 27/58; G01B 11/00

(52) U.S. Cl. 355/72; 356/401

(57) ABSTRACT

In one embodiment, a center of rotation and a slippage amount are estimated when slippage occurs due to radial runout during planar rotation θ to align the mask and the substrate. The slippage amount is estimated after rotation is reflected in a movement command value of a stage as a compensation value, and a moving table, on which the substrate is placed, is moved to compensate the slippage amount, thereby improving overlay performance.

### CROSS-REFERENCE TO RELATED APPLICATION(S)

This application claims the benefit of Korean Patent Application No. 2010-0078481, filed on Aug. 13, 2010 in the Korean Intellectual Property Office, the disclosure of which is incorporated herein by reference in its entirety.

### BACKGROUND

1. Field

Embodiments of the present invention relate to a method of estimating and compensating a slippage amount generated during rotation to align a mask and a substrate in an exposure apparatus.

2. Description of the Related Art

Generally, a method of forming a pattern on a substrate (or a semiconductor wafer) constituting a liquid crystal display (LCD), a plasma display panel (PDP), or a flat panel display (FPD) is performed as follows. First, a pattern material is applied to a substrate and is selectively exposed using a photomask such that a pattern material part, chemical properties of which have been changed, or the remaining part is selectively removed, thereby forming a pattern.

However, as substrate size is gradually increased and pattern precision is also gradually increased, a maskless exposure process for forming a pattern on a substrate (or a semiconductor wafer) without using a photomask has been developed. The maskless exposure eliminates costs for manufacturing/cleaning/maintaining a mask, allows a panel to be freely designed, and eliminates mask manufacturing time, thereby reducing lead time. Since mask defects are not an issue, the effects of mask defects on a fabrication process are eliminated. Because a hybrid layout is used, production flexibility is increased.

A plurality of layers is stacked on a substrate. The layers form a pattern on the substrate through an exposure process. The higher the pattern precision, the higher the number of layers each having the pattern. When a plurality of layers is stacked on one substrate, it may be desirable to align a mask and a substrate (or a semiconductor wafer) before exposure. The alignment between the mask and the substrate may be performed through a motion having three degrees of freedom (X, Y, θ).

### SUMMARY

At least one example embodiment provides a method of estimating and compensating a slippage amount due to radial runout generated during planar rotation (θ) to align a mask and a substrate.

Additional aspects of the embodiments will be set forth in part in the description which follows and, in part, will be obvious from the description, or may be learned by practice of the invention.

In one embodiment, an alignment error compensation method to align a mask and a substrate using a stage to transfer the substrate in at least one direction and a rotational body to rotate the substrate includes measuring a position of a fiducial mark during rotation of the rotational body to align the mask and the substrate, acquiring a position of a center of rotation of the rotational body using the measured position of the fiducial mark, estimating a slippage amount of the rotational body by determining a relative difference in position between the position of the center of rotation of the rotational body and the measured position of the fiducial mark, and compensating a movement amount of the stage based on the estimated slippage amount to align the mask and the substrate.

The fiducial mark may include at least one fiducial mark provided at the rotational body or at least one fiducial mark provided at the substrate.

The alignment between the mask (including a physical mask and a virtual mask) and the substrate may be performed through planar motions having three degrees of freedom (X, Y, θ).

The measuring may measure the position of the alignment mark before and after planar rotation (θ), the acquiring may acquire the position of the center of rotation before and after the planar rotation (θ), and the estimating may estimate the slippage amount by determining the relative difference between the position of the center rotation of the rotational body and the measured position of the alignment mark before and after the planar rotation (θ).

In one embodiment the method further includes performing a planar rotation (θ) of the rotational body to estimate the slippage amount of the rotational body.

The measuring may measure the positions of the fiducial mark before and after the planar rotation (θ) of the rotational body.

The acquiring the center of rotation and estimating the slippage amount of the rotational body may be performed simultaneously.

The acquiring may acquire the position of the center of rotation of the rotational body according to a positional change of the fiducial mark before and after rotation of the rotational body.

The estimating may estimate the slippage amount of the rotational body according to a positional change of the fiducial mark before and after rotation of the rotational body.

In another embodiment, an exposure apparatus to form a mask pattern on a substrate includes a stage configured to move the substrate in at least one direction, a rotational body stacked on the stage and configured to rotate the substrate, an alignment unit configured to measure a position of a fiducial mark during rotation of the rotational body to align the mask and the substrate, and a controller. The controller is configured to estimate a center of rotation and a slippage amount of the rotational body using the measured position of the fiducial mark, and is configured to compensate a movement amount of the stage based on the estimated slippage amount, thereby performing alignment between the mask and the substrate.

The alignment unit may include a scope to measure position coordinates of the fiducial mark before and after rotation of the rotational body.

The controller may be configured to estimate a center position of the rotational body according to the position coordinates of the fiducial mark before and after rotation of the rotational body, and may be configured to calculate a relative position between the center position of the rotational body and the measured position of the fiducial mark to estimate the slippage amount of the rotational body.

The controller may be configured to reflect the estimated slippage amount of the rotational body in a movement command value of the stage as a compensation value to compensate the slippage amount.

In a further embodiment, a method of estimating a center of rotation and a slippage amount of a rotational body that performs planar rotation includes measuring a position of a fiducial mark formed on the rotational body during the planar rotation of the rotational body, estimating a position of the center of rotation of the rotational body using the measured position of the fiducial mark, and determining a relative position between the position of the center of rotation of the rotational body and the measured position of the fiducial mark to estimate the slippage amount of the rotational body.

### BRIEF DESCRIPTION OF THE DRAWINGS

These and/or other aspects of the embodiments will become apparent and more readily appreciated from the following description of the embodiments, taken in conjunction with the accompanying drawings of which:

FIG. 1 is an overall construction view of an exposure apparatus according to an embodiment;

FIG. 2 is an operation conceptual view of the exposure apparatus according to the embodiment;

FIG. 3 is a control construction view of the exposure apparatus according to the embodiment;

FIG. 4 is a view illustrating a process of estimating a center of rotation during planar rotation for alignment in the exposure apparatus according to an embodiment;

FIG. 5 is a view illustrating a process of estimating a center of rotation and a slippage amount due to radial runout during planar rotation for alignment in the exposure apparatus according to an embodiment; and

FIG. 6 is an operation conceptual view of a measurement system according to another embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

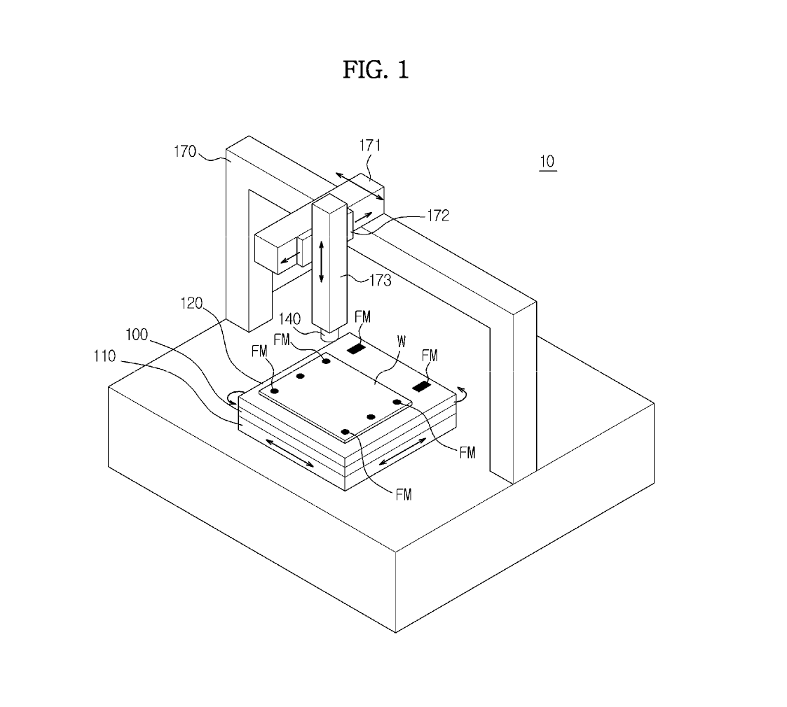

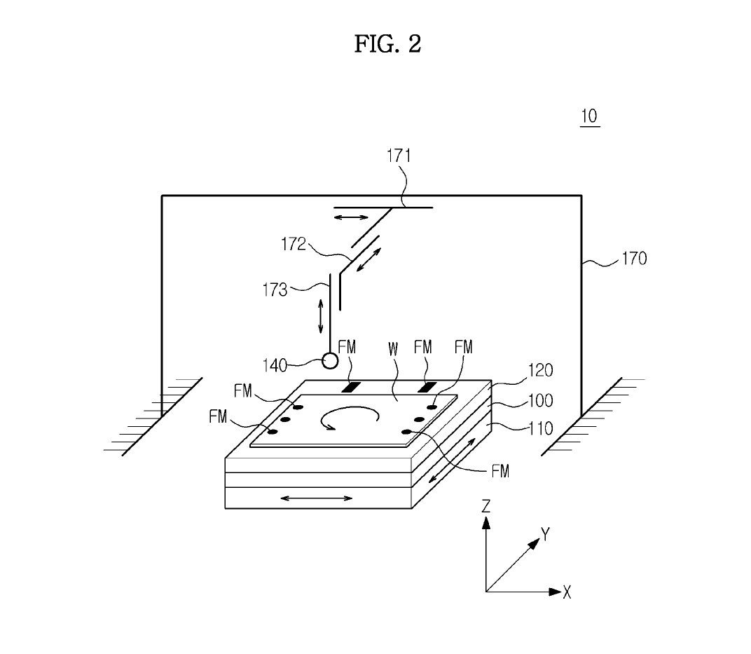

FIG. 1 is an overall construction view of an exposure apparatus 10 according to an embodiment, and FIG. 2 is an operation conceptual view of the exposure apparatus 10 according to the embodiment. Referring to FIGS. 1 and 2, the exposure apparatus 10 includes a moving table 100 on which a substrate (a sample, such as a semiconductor wafer or glass, on which a desired or predetermined pattern is to be formed) W is placed and an alignment unit 140 mounted above the moving table 100 to measure a position and posture of the substrate W placed on the moving table 100. The alignment unit 140 is mounted to a gantry 170 such that the alignment unit 140 moves in X-, Y- and Z-directions.

Guide bar type moving members 171, 172 and 173 are mounted to the gantry 170 such that the moving members 171, 172 and 173 move in the X-, Y- or Z-direction. The alignment unit 140 is coupled to the moving members 171, 172 and 173 such that the alignment unit 140 is moved in the X-, Y- or Z-direction. The alignment unit 140 has three degrees of freedom (X, Y, Z), which is the most common configuration. The degrees of freedom may be restricted. For example, the alignment unit 140 may have a degree of freedom in the X-, Y- or Z-direction.

The alignment unit 140 has three degrees of freedom (X, Y, Z) in which the alignment unit 140 moves in the X-, Y- and Z-directions according to the movements of the moving members 171, 172 and 173. The moving table 100, on which the substrate W is placed, has two degrees of freedom (X, Y) in which the moving table 100 moves in the X- and Y-directions according to the movement of an XY stage (hereinafter, referred to as a stage) 110.

Also, a θ stage (hereinafter, referred to as a rotational body) 120 is stacked on the moving table 100 such that the rotational body 120 performs rotation θ to align a mask or a virtual mask VM and the substrate W before exposure.

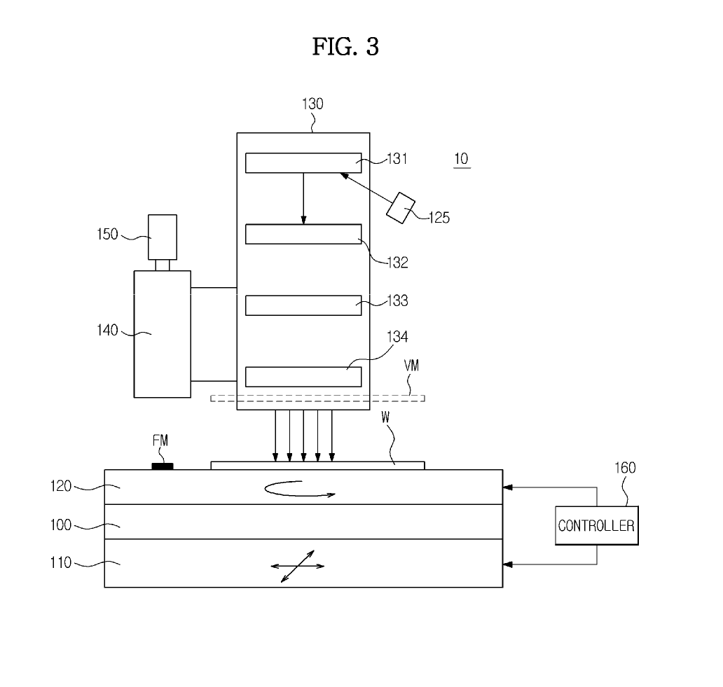

FIG. 3 is a control construction view of the exposure apparatus 10 according to the embodiment.

Referring to FIG. 3, the exposure apparatus 10 includes a stage 110, a rotational body 120, a light source unit 125, a projection unit 130, an alignment unit 140, a mark capturing unit 150, and a controller 160.

The stage 110 is a device to move the moving table 100, on which a substrate W to be exposed is placed, in the X- and Y-directions. The stage 110 translates the moving table 100 in the X- and Y-directions according to an instruction from the controller 160 when the virtual mask VM and the substrate W are aligned before exposure.

The rotational body 120 is a device stacked on the moving table 100 of the stage 110, which translates in the X- and Y-directions, to perform rotation θ according to an instruction from the controller 160 when the virtual mask VM and the substrate W are aligned before exposure. The rotational body 120 has at least one fiducial mark (FM).

The light source unit 125 outputs laser light for exposure. The light source unit 125 includes a semiconductor laser or an ultraviolet lamp. The laser light is output to the substrate W placed on the rotational body 120 through the projection unit 130.

The projection unit 130 is fixed to one side of the stage 110 to divide a pattern, which forms light to form a VM pattern, into a plurality of spot beams and project the spot beams onto the substrate W.

The projection unit 130 includes a light modulation element 131 to modulate light output from the light source unit 125 into light having a VM pattern, a first projection lens 132 to enlarge the light modulated by the light modulation element 131, a multi lens array (MLA) 133 including a plurality of lenses configured in the form of an array to split the light having the VM pattern enlarged by the first projection lens 132 into a plurality of lights and to condense the lights, and a second projection lens 134 to adjust a resolution of the light condensed by the MLA 133 and to allow the condensed light to pass therethrough.

The light modulation element 131 includes a spatial light modulator (SLM). For example, the light modulation element 131 may be any of a micro electro mechanical systems (MEMS)-type digital micro-mirror device (DMD), a two-dimensional grating light valve (GLV), an electro-optical element formed of lead zirconate titanate (PLZT), which is a translucent ceramic material, a ferroelectric liquid crystal (FLC), etc. Generally, DMDs are used. For convenience of description, the embodiments assume that the optical modulation element 131 is formed of the DMD.

The DMD is a mirror device including a memory cell and a plurality of micromirrors arranged on the memory cell in an L×M matrix. Based on a control signal generated in response to image data, the DMD changes angles of individual micromirrors, reflects and transmits a desired light to the first projection lens 132, and transmits the remaining light at a different angle such that the remaining light is blocked.

When a digital signal is recorded in a memory cell of the light modulation element 131 constituted by the DMD, each micromirror is inclined in the range of a desired (or, alternatively, a predetermined) angle (for example, 12°) on the basis of a diagonal line. On/off control operations of individual micromirrors are controlled by the controller 160, which will be described later. The light reflected from the ON-status micromirrors exposes an exposure target (generally, a photoresist PR) placed on the substrate W, and the light reflected from the OFF-status micromirrors does not expose the exposure target placed on the substrate W.

The first projection lens 132 is constituted by a double telecentric optical system. The first projection lens 132 magnifies an image output from the light modulation element 131, for example, at a magnification of approximately 4× and forms the magnified image on an aperture plane of the MLA 133.

The second projection lens 134 is also constituted by a double telecentric optical system. The second projection lens 134 magnifies a plurality of spot beams formed on a focal plane of the MLA 133, for example, at a magnification of approximately 1× and forms the magnified spot beams on the substrate W. In this embodiment, the first projection lens 132 has a magnification of 4× and the second projection lens 134 has a magnification of 1×. However, embodiments are not limited thereto. For example, magnifications of the first and second projection lenses 132 and 134 may be optimally adjusted according to the size of a spot beam and the minimum feature size of a pattern to be exposed.

In the MLA 133, a plurality of micro-lenses corresponding to micromirrors of the light modulation element 131 are two-dimensionally arranged. For example, assuming that the light modulation element 131 includes 1920×400 micromirrors, 1920×400 microlenses are also provided. A pitch of the microlens arrangement may be substantially identical to a value calculated when the magnification of the first projection lens 132 is multiplied by the micromirror arrangement pitch of the light modulation element 131.

The projection unit 130 generates a virtual mask VM having a pattern formed by the spot beams projected through the second projection lens 134.

The exposure apparatus 10 with the above-stated construction outputs light through the light source unit 125, and allows the light modulation element 131 to modulate the light output from the light source unit 125 into light having a VM pattern. The first projection lens 132 magnifies the VM-patterned light modulated by the light modulation unit 131. The MLA 133 splits the magnified VM-patterned light into a plurality of spot beams and allows the spot beams to be condensed. The second projection lens 134 adjusts a resolution of the light condensed by the MLA 133 and allows the condensed light to penetrate therethrough, thereby performing exposure.

The alignment unit 140 may be a scope provided above the stage 110 to measure the position of a fiducial mark FM formed on the rotational body 120 to perform overlay alignment.

The mark capturing unit 150 is provided above the alignment unit 140 to capture the fiducial mark FM formed on the rotational body 120 and transmit the captured image to the controller 160. At this time, the movement of the rotational body 120 is controlled according to an instruction from the controller 160 until the fiducial mark FM is captured by the mark capturing unit 150.

The controller 160 estimates a center of rotation and a slippage amount of the rotational body 120 using a fiducial mark FM measured by the alignment unit 140, reflects the estimated slippage amount in a movement command value of the stage 110 as a compensation value, and moves the moving table 100 to compensate the slippage amount.

In this way, the controller 160 estimates and compensates the center of rotation and the slippage amount of the substrate W using the fiducial mark FM when the virtual mask VM and the substrate W are aligned before exposure.

In this embodiment, the exposure apparatus 10 is a maskless exposure apparatus using a virtual mask VM. However, embodiments are not limited thereto. For example, the exposure apparatus 10 may be a mask exposure apparatus.

Hereinafter, a method of estimating a center of rotation and a slippage amount using a fiducial mark FM when a virtual mask VM and a substrate W are aligned for overlay during exposure will be described.

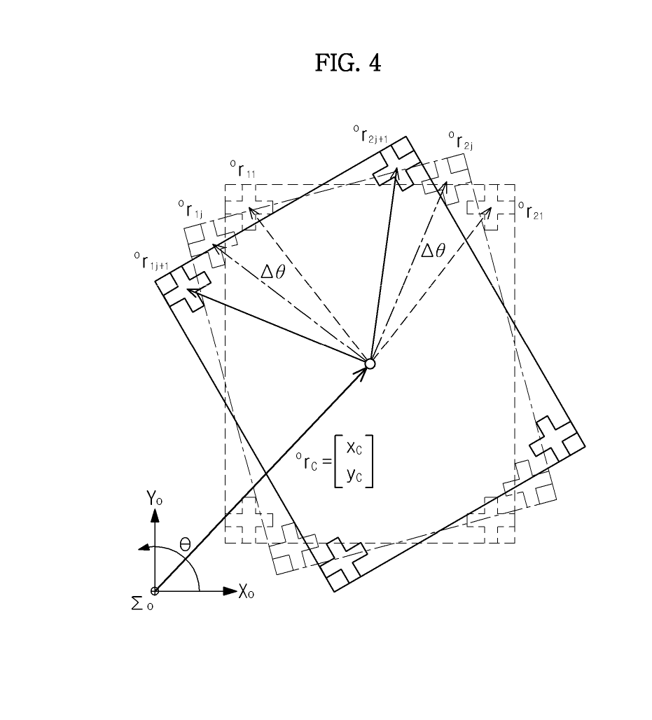

FIG. 4 is a view illustrating a process of estimating a center of rotation during planar rotation for alignment in the exposure apparatus according to the embodiment.

Referring to 4, at least one fiducial mark FM is formed on the rotational body 120. Alternatively, as least one fiducial mark FM may be formed on the substrate W. In this embodiment, two or more fiducial marks FM are formed on the rotational body 120.

The fiducial marks FM formed on the rotational body 120 (or alignment marks formed on the substrate; hereinafter, referred to as fiducial marks for convenience of description) in a field of view F.O.V. of the alignment unit 140 are measured. Physical quantities defined to measure the fiducial marks FM are as follows.

The following physical quantities may be regarded as a two-dimensional vector amount (position vector).

Although the physical quantities are denoted by a three-dimensional vector (X, Y, Z), XY-plane leveling is performed in such a manner that all Z-axis coordinates are identical to one another. Therefore, Z is a constant, and thus Z is denoted by ‘0’ (Z=0) for convenience of description.

Σ_{O} is a fiducial coordinate system related to an overlay to achieve alignment between the virtual mask VM and the substrate W.

Σ_{C} is a body fixed coordinate system of the rotational body 120 (hereinafter, referred to as a rotation coordinate system).

^{O}r_{C} is the position of a center of rotation of the rotational body 120.

When a substrate (semiconductor wafer or glass) W is placed on the moving table 100 and several layers L (L1, L2 . . . ) are stacked on the substrate W, the position of at least one fiducial mark FM (^{O}rᵢⱼ, ^{O}rᵢⱼ₊₁), formed on the rotational body 120 so as to achieve alignment between the substrate W and the virtual mask VM before exposure, is measured using the alignment unit 140 as represented by Equation 1 (see FIG. 4).

^{O}rᵢⱼ=Xᵢⱼ,Yᵢⱼ

^{O}rᵢⱼ₊₁=Xᵢⱼ₊₁,Yᵢⱼ₊₁ [Equation 1]

In Equation 1, ^{O}rᵢⱼ is an i-th measured (before rotation) position of an i-th fiducial mark FM on the fiducial coordinate system Σ_{O}, and ^{O}rᵢⱼ₊₁ is an (i+1)-th measured (after rotation) position of the i-th fiducial mark FM on the fiducial coordinate system Σ_{O}.

The position of a center of rotation ^{O}r_{C} is calculated through Equation 2 using the coordinate values of ^{O}rᵢⱼ and ^{O}rᵢⱼ₊₁ measured at the i-th fiducial mark FM as represented by Equation 1.

$$‖ {}_{}^{O}{r}{}_{ij}^{} - {}_{}^{O}{r}{}_{C}^{} ‖ = ‖ {}_{}^{O}{r}{}_{ij + 1}^{} - {}_{}^{O}{r}{}_{C}^{} ‖ \\ {}_{}^{O}{r}{}_{C}^{} = [ \begin{matrix}{x}_{C} \\ {y}_{C}\end{matrix} ] \qquad [ Equation 2 ]$$

In Equation 2, ∥^{O}rᵢⱼ−^{O}r_{C}∥ is the distance between a mark position ^{O}rᵢⱼ before rotation of the rotational body 120 and the center of rotation ^{O}r_{C}, and ∥^{O}rᵢⱼ₊₁−^{O}r_{C}∥ is the distance between a mark position ^{O}rᵢⱼ₊₁ after rotation of the rotational body 120 and the center of rotation ^{O}r_{C}.

As is apparent from Equation 2, the distance between the mark position ^{O}rᵢⱼ before rotation and the center of rotation ^{O}r_{C} is equal to the distance between the mark position ^{O}rᵢⱼ₊₁ after rotation and the center of rotation ^{O}r_{C}, and therefore, the position of the center of rotation ^{O}r_{C} is calculated.

Therefore, Equation 3 and Equation 4 may be defined using Equation 2.

$$\begin{matrix}[ \begin{matrix}2 {x}_{ij + 1} - 2 {x}_{ij} & 2 {y}_{ij + 1} - 2 {y}_{ij}\end{matrix} ] [ \begin{matrix}{x}_{C} \\ {y}_{C}\end{matrix} ] = [ ( {x}_{ij + 1}^{2} - {x}_{ij}^{2} ) + ( {y}_{ij + 1}^{2} - {y}_{ij}^{2} ) ] & [ Equation 3 ] \\ [ \begin{matrix}2 {x}_{12} - 2 {x}_{11} & 2 {y}_{12} - 2 {y}_{11} \\ ⋮ & ⋮ \\ 2 {x}_{1 n} - 2 {x}_{1 n - 1} & 2 {y}_{1 n} - 2 {y}_{1 n - 1} \\ 2 {x}_{ij + 1} - 2 {x}_{ij} & 2 {y}_{ij + 1} - 2 {y}_{ij} \\ 2 {x}_{22} - 2 {x}_{21} & 2 {y}_{22} - 2 {y}_{21} \\ ⋮ & ⋮ \\ 2 {x}_{2 n} - 2 {x}_{2 n - 1} & 2 {y}_{2 n} - 2 {y}_{2 n - 1}\end{matrix} ] [ \begin{matrix}{x}_{C} \\ {y}_{C}\end{matrix} ] = [ \begin{matrix}( {x}_{12}^{2} - {x}_{11}^{2} ) + ( {y}_{12}^{2} - {y}_{11}^{2} ) \\ ⋮ \\ ( {x}_{1 n}^{2} - {x}_{1 n - 1}^{2} ) + ( {y}_{1 n}^{2} - {y}_{1 n - 1}^{2} ) \\ ( {x}_{ij + 1}^{2} - {x}_{ij}^{2} ) + ( {y}_{ij + 1}^{2} - {y}_{ij}^{2} ) \\ ( {x}_{22}^{2} - {x}_{21}^{2} ) + ( {y}_{21}^{2} - {y}_{22}^{2} ) \\ ⋮ \\ ( {x}_{2 n}^{2} - {x}_{2 n - 1}^{2} ) + ( {y}_{2 n}^{2} - {y}_{2 n - 1}^{2} )\end{matrix} ] & [ Equation 4 ]\end{matrix}$$

Equation 4 shows examples of measured mark positions of two fiducial marks r_{i=1,2} before and after rotation when the rotational body 120 is rotated n−1 times.

Equation 4 may be simply expressed as represented by Equation 5.

$$A \cdot {}_{}^{O}{r}{}_{C}^{} = b ⇒ {}_{}^{O}{r}{}_{C}^{} = [ \begin{matrix}{x}_{C} \\ {y}_{C}\end{matrix} ] = {A}^{+} \cdot b = {( {A}^{T} A )}^{- 1} {A}^{T} \cdot b \qquad [ Equation 5 ]$$

In this way, the positions of the fiducial mark formed on the rotational body 120 before and after rotation may be measured to estimate the position of the center of rotation ^{O}r_{C} of the rotational body 120.

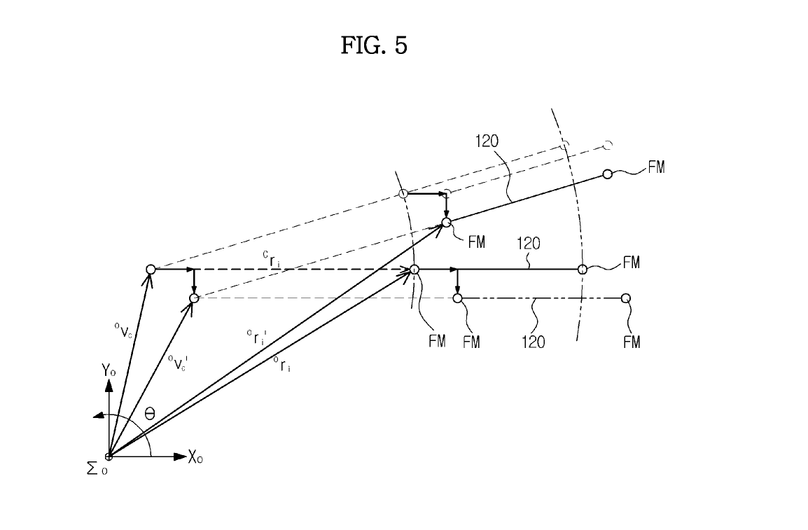

As shown in FIG. 4, the rotational body 120 is ideally rotated about a constant center of rotation ^{O}r_{C}. Generally, however, radial runout is generated in the rotational body 120 mainly due to mechanical causes, with the result that the center of rotation of the rotational body 120 is not uniform. That is, slippage of the rotational body 120 occurs, which will be described with reference to FIG. 5.

FIG. 5 is a view illustrating a process of estimating a center of rotation and a slippage amount due to radial runout during planar rotation for alignment in the exposure apparatus according to the embodiment. FIG. 5 shows a case in which slippage occurs when the rotational body 120 is rotated by a desired (or, alternatively, a predetermined) angle to align the substrate W and the virtual mask VM.

In FIG. 5, the rotational body 120 is shown as a straight line for convenience.

A center of rotation ^{O}v_{C} and a slippage amount Δv_{C} of the rotational body 120 is calculated using Equation 6.

Δv_{C}=v_{C}′−v_{C}=[X_{S}Y_{S}]

^{O}r′ᵢ=(^{O}v_{C}+Δv_{C})+R(θ)·^{C}rᵢ [Equation 6]

In Equation 6,

$$θ = arg ( {}_{}^{O}{r}{}_{i + 1}^{′} - {}_{}^{O}{r}{}_{i}^{′} ) - arg ( {}_{}^{O}{r}{}_{i + 1}^{} - {}_{}^{O}{r}{}_{i}^{} )$$

$$R ( θ ) = [ \begin{matrix}cos θ & - sin θ \\ sin θ & cos θ\end{matrix} ]$$

$${}_{}^{C}{r}{}_{i}^{} = {}_{}^{O}{r}{}_{i}^{} - {}_{}^{O}{v}{}_{C}^{} ,$$

^{O}rᵢ, is a position of the i-th fiducial mark FM measured before rotation on the fiducial coordinate system Σ_{O}, ^{O}r′ᵢ is a position of the i-th fiducial mark FM measured after rotation on the fiducial coordinate system Σ_{O}, and ^{O}rⱼ is a measured position of the i-th fiducial mark FM on the rotation coordinate system Σ_{C}.

Meanwhile, Δv_{C} and ^{O}v_{C} in Equation 6 are values to be calculated.

Coordinate values of ^{O}rᵢ and ^{O}r′ᵢ in Equation 6 are measured using the alignment unit 140 as represented by Equation 7 (see FIG. 5).

$${}_{}^{O}{r}{}_{i}^{} = [ \begin{matrix}{X}_{i} \\ {Y}_{i}\end{matrix} ] \\ {}_{}^{O}{r}{}_{i}^{′} = [ \begin{matrix}{X}_{i}^{′} \\ {Y}_{i}^{′}\end{matrix} ] \\ {}_{}^{O}{v}{}_{C}^{} = [ \begin{matrix}{X}_{C} \\ {Y}_{C}\end{matrix} ] \qquad [ Equation 7 ]$$

A center of rotation (X_{C}, Y_{C}) and a slippage amount (X_{S}, Y_{S}) may be expressed in the form of a matrix vector using Equation 7 as represented by Equation 8.

^{O}r′ᵢ=(^{O}v_{C}+Δv_{C})+R(θ)·^{C}rᵢ=(^{O}v_{C}+Δv_{C})+R(θ)·(^{O}rᵢ−^{O}v_{C})

X′ᵢ=(Xᵢ cos θ−Yᵢ sin θ)+X_{S}+X_{C}(1−cos θ)+Y_{C} sin θ

Y′ᵢ=(Xᵢ sin θ+Yᵢ cos θ)+Y_{S}−X_{C} sin θ+Y_{C}(1−cos θ) [Equation 8]

In Equation 8, the center of rotation (X_{C}, Y_{C}) and the slippage amount (X_{S}, Y_{S}) are unknown, and two equations are indeterminate, with the result that a unique solution is not obtained.

Therefore, the equation is solved using a least squares method (LSM) as represented by Equation 9.

$${ }^{O} {r}_{i}^{′} = ( {}_{}^{O}{v}{}_{C}^{} + Δ {v}_{C} ) + R ( θ ) \cdot {}_{}^{C}{r}{}_{i}^{} + ( residual ) \\ \begin{matrix}⇒ ( residual ) = {e}_{i} \\ = {}_{}^{O}{r}{}_{i}^{′} - [ ( {}_{}^{O}{v}{}_{C}^{} + Δ {v}_{C} ) + R ( θ ) \cdot {}_{}^{C}{r}{}_{i}^{} ] \\ = ( {}_{}^{O}{r}{}_{i}^{′} - {}_{}^{O}{v}{}_{C}^{} ) - [ Δ {v}_{C} + R ( θ ) \cdot ( {}_{}^{O}{r}{}_{i}^{} - {}_{}^{O}{v}{}_{C}^{} ) ]\end{matrix} \\ ∴ minimizing {\sum }_{i = 1}^{n} {‖ {e}_{i} ‖}^{2} = {\sum }_{i = 1}^{n} {e}_{i}^{T} \cdot {e}_{i} \qquad [ Equation 9 ]$$

In Equation 9, each component is

eᵢ|ₓ=rₓ=(X′ᵢ−X_{C})−[X_{S}+(Xᵢ−X_{C})cos θ−(Yᵢ−Y_{C})sin θ]

eᵢ|_{y}=r_{y}=(Y′ᵢ−Y_{C})−[Y_{S}+(Xᵢ−X_{C})sin θ+(Yᵢ−Y_{C})cos θ]

In Equation 9, an optimization problem to minimize the sum of the square of a residual is solved to calculate the center of rotation ^{O}v_{C}=[X_{C}, Y_{C}] and the slippage amount Δv_{C}=[X_{S}, Y_{S}] of the rotational body 120.

In addition, the position of the center of rotation ^{O}r_{C}=^{O}v_{C}=[X_{C}, Y_{C}] of the rotational body 120 calculated through Equation 1 to Equation 5 may be introduced to calculate the slippage amount Δv_{C}=[X_{S}, Y_{S}] of the rotational body 120 as represented by Equation 10.

X_{S}=X′ᵢ−Xᵢ cos θ+Yᵢ sin θ−X_{C}(1−cos θ)−Y_{C} sin θ

X_{S}=Y′ᵢ−Xᵢ sin θ−Yᵢ cos θ+X_{C} sin θ−Y_{C}(1−cos θ) [Equation 10]

The slippage amount may be compensated using the center of rotation ^{O}v_{C}=[X_{C}, Y_{C}] and the slippage amount Δv_{C}=[X_{S}, Y_{S}] of the rotational body 120 estimated through Equation 9 and Equation 10.

For example, when the substrate W is placed on the moving table 100, which performs planar motions in three degrees of freedom (X, Y, θ) to process/manufacture/inspect the substrate W, command values, such as X=X_{cmd}, Y=Y_{cmd}, and θ=θ_{cmd}, are transmitted from the controller 160 to the stage 110. The fiducial mark FM or the alignment mark formed on the substrate W before and after rotation θ=θ_{cmd} is measured to estimate the slippage amount using the above-mentioned equation. The estimated slippage amount is reflected in the XY movement command value as a compensation value as represented by Equation 11.

Command values before compensation: X=X_{cmd},Y=Y_{cmd},θ=θ_{cmd}

Commands values after compensation: X=X_{cmd}−X_{S},Y=Y_{cmd}−X_{S},θ=θ_{cmd} [Equation 11]

In conclusion, XY translation caused due to radial runout generated during planar rotation θ to align the virtual mask VM and the substrate W may be offset through compensation of the slippage amount as represented by Equation 11.

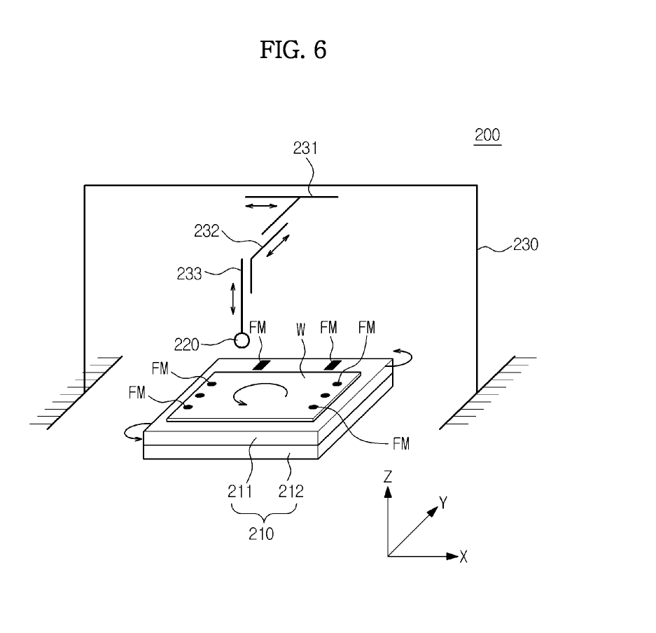

In FIGS. 1 to 3, the exposure apparatus 10 uses a physical mask or a virtual mask. However, embodiments are not limited to the exposure apparatus 10. For example, embodiments may be applied to a rotational body that performs planar rotation, which will be described with reference to FIG. 6.

FIG. 6 is an operation conceptual view of a measurement system 200 according to another embodiment of the present invention.

Referring to FIG. 6, the measurement system 200 includes a rotational body 210 on which a substrate (a sample, such as a semiconductor wafer or glass, on which a predetermined pattern is to be formed) W is placed and an alignment unit 220 mounted above the rotational body 210 to measure a position and posture of the substrate W placed on the rotational body 210. The alignment unit 220 is mounted to a gantry 230 such that the alignment unit 220 moves in X-, Y- and Z-directions.

Guide bar type moving members 231, 232 and 233 are mounted to the gantry 230 such that the moving members 231, 232 and 233 move in the X-, Y- or Z-direction. The alignment unit 220 is coupled to the moving members 231, 232 and 233 such that the alignment unit 220 is moved in the X-, Y- or Z-direction. The alignment unit 220 has three degrees of freedom (X, Y, Z), which is the most common configuration. The degrees of freedom may be restricted. For example, the alignment unit 220 may have a degree of freedom in the X-, Y- or Z-direction.

The alignment unit 220 has three degrees of freedom (X, Y, Z) in which the alignment unit 220 moves in the X-, Y- and Z-directions according to movement of the moving members 231, 232 and 233.

The rotational body 210, on which the substrate W is placed, includes an upper plate 211 and a lower plate 212. The upper plate 211 is a rotor that performs planar rotation θ, and the lower plate 212 is a stator.

In the measurement system 200 with the above-stated construction, the alignment unit 220 is moved during planar rotation θ of the device that performs planar rotation θ (specifically, the rotational body) to measure the position of a fiducial mark FM formed on the rotational body 210 or the position of an alignment mark (referred to as a fiducial mark FM for convenience) formed on the substrate W, thereby estimating a center of rotation and a slippage amount of the rotational body 210. A process of estimating the center of rotation and a slippage amount of the rotational body 210 is identical to that shown in FIGS. 4 and 5.

As is apparent from the above description, the exposure apparatus and the alignment error compensation method using the same, estimate and compensate a center of rotation and a slippage amount, when slippage occurs due to radial runout during planar rotation θ to align a mask (including a virtual mask) and a substrate, thereby improving overlay performance.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An alignment error compensation method to align a mask and a substrate using a stage to transfer the substrate in at least one direction and a rotational body to rotate the substrate, the alignment error compensation method comprising:
measuring a position of a fiducial mark during rotation of the rotational body to align the mask and the substrate;
acquiring a position of a center of rotation of the rotational body using the measured position of the fiducial mark;
estimating a slippage amount of the rotational body by determining a relative difference in position between the position of the center of rotation of the rotational body and the measured position of the fiducial mark; and
compensating a movement amount of the stage based on the estimated slippage amount to align the mask and the substrate.

2. The alignment error compensation method according to claim 1, wherein the fiducial mark comprises at least one fiducial mark provided at the rotational body.

3. The alignment error compensation method according to claim 1, wherein the fiducial mark comprises at least one fiducial mark provided at the substrate.

4. The alignment error compensation method according to claim 1, wherein alignment between the mask and the substrate is performed through planar motions having three degrees of freedom (X, Y, θ).

5. The alignment compensation method according to claim 4, wherein
the measuring measures the position of the alignment mark before and after planar rotation (θ);
the acquiring acquires the position of the center of rotation before and after the planar rotation (θ); and
the estimating estimates the slippage amount by determining the relative difference between the position of the center of rotation of the rotational body and the measured position of the alignment mark before and after the planar rotation (θ).

6. The alignment error compensation method according to claim 2, further comprising:
performing a planar rotation (θ) of the rotational body to estimate the slippage amount of the rotational body.

7. The alignment error compensation method according to claim 6, wherein the measuring measures the positions of the fiducial mark before and after the planar rotation (θ) of the rotational body.

8. The alignment error compensation method according to claim 3, further comprising:
performing a the planar rotation (θ) of the rotational body to estimate the slippage amount of the rotational body.

9. The alignment error compensation method according to claim 8, wherein the measuring measures the positions of the fiducial mark before and after the planar rotation (θ) of the rotational body.

10. The alignment error compensation method according to claim 7, wherein the acquiring the center of rotation and the estimating the slippage amount of the rotational body are performed simultaneously.

11. The alignment error compensation method according to claim 7, wherein the acquiring acquires the position of the center of rotation of the rotational body according to a positional change of the fiducial mark before and after rotation of the rotational body.

12. The alignment error compensation method according to claim 11, wherein the estimating estimates the slippage amount of the rotational body according to a positional change of the fiducial mark before and after rotation of the rotational body.

13. An exposure apparatus to form a mask pattern on a substrate, comprising:
a stage configured to move the substrate in at least one direction;
a rotational body stacked on the stage and configured to rotate the substrate;
an alignment unit configured to measure a position of a fiducial mark during rotation of the rotational body to align the mask and the substrate; and
a controller configured to estimate a center of rotation and a slippage amount of the rotational body using the measured position of the fiducial mark, and configured to compensate a movement amount of the stage based on the estimated slippage amount.

14. The exposure apparatus according to claim 13, wherein the alignment between the mask and the substrate is performed through planar motions having three degrees of freedom (X, Y, θ).

15. The exposure apparatus according to claim 14, wherein the controller controls the rotational body to perform rotation (θ) of the substrate to estimate the center of rotation and the slippage amount of the rotational body.

16. The exposure apparatus according to claim 13, wherein the alignment unit comprises a scope to measure position coordinates of the fiducial mark before and after rotation of the rotational body.

17. The exposure apparatus according to claim 16, wherein the controller is configured to estimate a center position of the rotational body according to the position coordinates of the fiducial mark before and after rotation of the rotational body, and is configured to calculate a relative position between the center position of the rotational body and the measured position of the fiducial mark to estimate the slippage amount of the rotational body.

18. The exposure apparatus according to claim 17, wherein the controller is configured to reflect the estimated slippage amount of the rotational body in a movement command value of the stage as a compensation value to compensate the slippage amount.

19. A method of estimating a center of rotation and a slippage amount of a rotational body that performs planar rotation, the method comprising:
measuring a position of a fiducial mark formed on the rotational body during the planar rotation of the rotational body;
estimating a position of the center of rotation of the rotational body using the measured position of the fiducial mark; and
determining a relative position between the position of the center of rotation of the rotational body and the measured position of the fiducial mark to estimate the slippage amount of the rotational body.

20. The method according to claim 19, wherein the measuring measures positions of the fiducial mark before and after the planar rotation (θ) of the rotational body.

21. The method according to claim 20, wherein the estimating a position of the center of rotation and the estimating slippage amount of the rotational body are performed simultaneously according to a positional change of the fiducial mark before and after rotation of the rotational body.
